(19) United States
(12) Patent Application Publication
(10) Pub. No.: US 2013/0106944 A1
(43) Pub. Date: May 2, 2013

(54) SEALANT FOR INKJET HEAD

(71) Applicant: CANON KABUSHIKI KAISHA, Tokyo (JP)

(72) Inventor: Akane Hisanaga, Tokyo (JP)

(73) Assignee: CANON KABUSHIKI KAISHA, Tokyo (JP)

(21) Appl. No.: 13/660,830

(22) Filed: Oct. 25, 2012

(30) Foreign Application Priority Data
Oct. 28, 2011 (JP) 2011-237518

(51) Int. Cl. B41J 2/015; C09D 163/02

(52) U.S. Cl. 347/20; 523/400

(57) ABSTRACT

Disclosed is a sealant for an inkjet head (1) which can achieve compatibility between shape retention and uniform filling property, (2) in which breaking of members due to material properties in cured product is unlikely to occur, (3) which has good adhesiveness, and (4) which has a long working life. The sealant for an inkjet head contains an epoxy resin having a bisphenol structure and a latent curing agent, in which the sealant for an inkjet head has a coefficient of linear expansion of 80 ppm/° C. or less.

### BACKGROUND OF THE INVENTION

1. Field of the Invention

The present invention relates to a sealant for an inkjet head.

2. Description of the Related Art

An inkjet head used in an inkjet recording method includes a plurality of different members, such as a metal, a thermoplastic resin, a ceramic, and a silicon substrate. As a sealant suitable for sealing spaces between such different members, a one-part thermosetting epoxy resin composition which does not require mixing of a base resin and a curing agent, or the like has been known (refer to Japanese Patent No. 3794349 [Patent Literature 1]). Furthermore, as a sealant in which the amount of stress applied to a sealing resin is decreased and crack resistance in a thermal crack test is improved, a liquid sealing resin composition composed of an epoxy resin has been known (refer to Japanese Patent Laid-Open No. 2001-89638 [Patent Literature 2]).

### SUMMARY OF THE INVENTION

The present invention provides a sealant for an inkjet head, the sealant containing an epoxy resin having a bisphenol structure and a latent curing agent, in which the sealant has a coefficient of linear expansion of 80 ppm/° C. or less.

Further features of the present invention will become apparent from the following description of exemplary embodiments with reference to the attached drawings.

### BRIEF DESCRIPTION OF THE DRAWINGS

FIGS. 1A and 1B are schematic views showing a structure of an inkjet recording head.

FIG. 2 is a cross-sectional view of the inkjet recording head.

### DESCRIPTION OF THE EMBODIMENTS

The present inventors have found that the problems described below arise when an inkjet head is sealed with a resin composition.

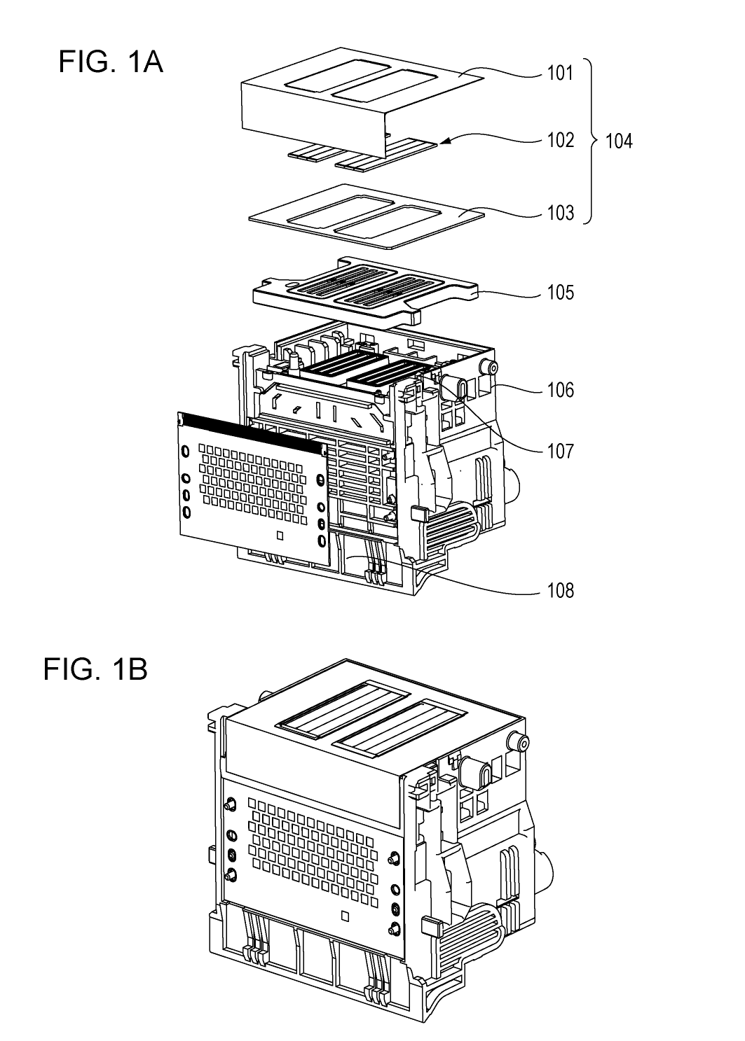

An inkjet head has a configuration in which a recording element unit 104, a chip plate 105, and a supporting member 106 are joined together, as shown in FIG. 1A. The recording element unit 104 includes an electric wiring sheet 101 fabricated by tape-automated bonding (TAB) method, recording element substrates 102 having elements that generate energy for ejecting ink, and a deformation-preventing member 103 that prevents deformation of the electric wiring sheet 101. Principally, the deformation-preventing member 103 is composed of alumina or the like, and the supporting member 106 is composed of modified polyphenylene ether (PPE) or the like. Design is made such that the chip plate 105 is incorporated into the supporting member 106, thus facilitating assembly. Furthermore, a sealant composed of a resin or the like is used in order to seal the space between the deformation-preventing member 103 and the supporting member 106.

### (1) Compatibility Between Shape Retention and Uniform Filling Property

Inkjet heads have a complicated structure in many cases. In view of application of a sealant, a resin application portion provided for filling a space can have a groove. For example, there may be an L-shaped structure in which an upright wall rising from the bottom surface of the groove is provided on one side only. Furthermore, there may be a structure in which a resin application surface does not face upward, but lies on a side wall surface.

In the case where a resin is used for sealing, when the resin has good flowability, discontinuity and entrapment of bubbles are unlikely to occur, and the resin can be easily applied. On the other hand, the resin may flow out of the joint, and it may not be possible to sufficiently fill the space. In particular, under the conditions where curing is performed by heating, since the viscosity of the resin is decreased briefly, although filling tends to be performed more uniformly, there is an increased concern that the resin may flow out of the sealing portion. In order to deal with this problem, a low-temperature rapid curing resin can be used. However, in the case where bubbles and the like are generated during application of the resin, the resin may be cured in that state, resulting in a possibility that the uniform filling property may be impaired. In recent years, in order to improve image quality of printed matter, there has been a tendency to markedly decrease the distance between an inkjet head and a recording medium, such as paper. Therefore, even a small amount of ink remaining in a minute space may affect the image owing to contact with printed matter or the like. As described above, it is very difficult to achieve both shape retention and a uniform filling property.

### (2) Breaking of Members Due to Material Properties in Cured Product

Alumina is generally used as a deformation-preventing member of an inkjet head, and its coefficient of linear expansion is about 5 to 10 ppm/° C. On the other hand, a resin, such as modified PPE, is generally used as a supporting member, and the supporting member has a larger coefficient of linear expansion than the deformation-preventing member. Consequently, in the case where a liquid resin is applied into the space between the two members and cured or the space is filled with a solid or putty resin, followed by curing, if the coefficient of linear expansion of the resin is largely different from that of each of the two members, there is a possibility that the members may be broken when subjected to a change in temperature, such as thermal curing or a thermal crack test. The reason for this is believed to be that differences in the degree of expansion among the members and the infilling generate stress. In particular, since the deformation-preventing member is a thin plate, cracking is likely to occur. Furthermore, even if the coefficients of linear expansion are in desirable ranges, in the case where the resin filling the space is hard and has a substantially constant hardness within the range of the change in temperature, there may be a possibility that the joint interface is subjected to stress while the member serving as an adherend repeatedly expands and contracts, resulting in interfacial peeling and breaking of the resin cured product or the members. Since the deformation-preventing member is provided for the purpose of preventing deformation of the electric wiring sheet, breaking of the deformation-preventing member may also cause damage to the electric wiring sheet. Furthermore, since the recording element substrates that eject ink are placed inside the deformation-preventing member, there is a concern that electrical short-circuiting may occur when ink penetrates into cracked portions.

### (3) Adhesiveness

Sealants having various forms, such as solid, paste, and liquid forms, are used for filling spaces. Since the space in an inkjet head is minute and has a complicated structure and in view of workability in the manufacturing process, filling is performed using a liquid resin in many cases. The resin may not have adhesiveness when used only for the purpose of filling the space. However, in the case where a new opening is produced between a member and the sealant because the inkjet head is subjected to impact shock due to falling or the like, or under the influence of shrinkage due to degradation of the sealant, ink may accumulate in the opening, which is not desirable as described in item (1) above. Therefore, the sealant is required not only to perform sealing but also to bond members.

### (4) Working Life

In the case where a sealant is desired to be used for a long period of time in the manufacturing process, if the viscosity increases, it becomes difficult to stably control the amount of application, resulting in a decrease in working efficiency, or the sealant has to be disposed of before full use has been made, which is wasteful. A method may be employed in which the sealant is used at low temperatures in order to inhibit a reaction from proceeding. However, a reduction in temperature leads to solidification of the composition, which may rather result in a decrease in working efficiency.

As a result of studies on the problems described above, it has been found that the sealant described in Patent Literature 1 is advantageous in terms of items (2), (3), and (4), but has a problem in terms of item (1) because flowability is actively imparted to the sealant. Furthermore, the sealant described in Patent Literature 2 is advantageous in terms of items (1), (2), and (4), but has a problem in terms of item (3). That is, there may be a case where adhesiveness is insufficient.

The present invention provides a sealant for an inkjet head in which the problems in items (1) to (4) can be solved.

The present invention will be described in detail below on the basis of specific examples. However, the present invention is not limited to the embodiments described below.

### (Sealant for Inkjet Head)

A sealant according to the present invention is suitable as a sealant for an inkjet head. A recording element unit of an inkjet head includes a member composed of alumina or the like (deformation-preventing member) and a supporting member composed of modified PPE or the like, and a sealant needs to seal the space between them and satisfactorily join the two members together.

Since the two members are composed of different materials, there is a possibility that a difference in thermal expansion caused by a change in temperature may result in thermal stress, which may cause the members to break, and the like. Alumina used for the deformation-preventing member has a low coefficient of linear expansion of 5 to 10 ppm/° C. On the other hand, a modified PPE resin constituting the supporting member has a coefficient of linear expansion of 50 to 60 ppm/° C., which is higher than that of the deformation-preventing member. In the case where the difference between each of the two members and a sealant disposed therebetween is large, they exhibit different thermal expansion values and expansion and contraction values when subjected to a change in temperature due to thermal curing or the like. Therefore, the members are subjected to stress, which may result in the members breaking or the sealant peeling. The present inventors have found that by setting the coefficient of linear expansion of the sealant at 80 ppm/° C. or less, these problems can be suppressed. In view of manufacturing, the coefficient of linear expansion of the sealant can be 5 ppm/° C. or more. Furthermore, the coefficient of linear expansion of the sealant according to the present invention can be in the range between the coefficients of linear expansion of the two members. That is, in the case where the deformation-preventing member has a coefficient of linear expansion of 5 ppm/° C. and the supporting member has a coefficient of linear expansion of 60 ppm/° C., the coefficient of linear expansion of the sealant can be in the range of 5 to 60 ppm/° C. Regarding the coefficient of thermal expansion, the coefficient of linear expansion is defined as the ratio of change in length to increase in temperature, and can be determined by thermal mechanical analysis (TMA). In the present invention, the coefficient of linear expansion of a sealant is measured in a tensile mode, and the thermal expansion of a sample under a tensile load is calculated as a function of temperature.

Regarding the sealant according to the present invention, in addition to the coefficient of linear expansion described above, mechanical material properties can be taken into consideration. A polymer material such as a cured product of an epoxy resin is known as a viscoelastic body and has both a rigidity component (elasticity) and a viscous component (viscosity). In the present invention, using an apparatus for carrying out dynamic viscoelasticity measurement (DMA), which is known as one of evaluations for mechanical properties, viscoelastic values are obtained from the stress response when a sample is subjected to sinusoidal oscillation in a tensile mode. This method is characterized in that, temperature dependence and frequency dependence of the storage elastic modulus (E′) which is an elastic component, the loss elastic modulus (E″) which is a viscous component, the loss tangent (tan δ=E′/E″) which serves as an index for stress absorption, and the like, as the viscoelastic properties of the sample, can be measured at the same time. Furthermore, the glass transition temperature (Tg) can be measured with high accuracy from the temperature at which tan δ has the maximum value. When a structure, in which members having different coefficients of linear expansion are sealed and joined together with an epoxy resin, is left in an environment where a change in temperature occurs, such as in a thermal crack test, stress occurs owing to the difference in coefficient of linear expansion, and the cured product of the epoxy resin, which is a viscoelastic body, is deformed. Most of the force applied at that time is stored as deformation energy, and stress acts as restoration energy. Because of internal friction caused by strain, some of the force is finally consumed as thermal energy. The magnitude of the internal friction is expressed by the loss tangent (tan δ), and a larger value indicates higher stress absorption. Furthermore, the viscoelastic body is changed into a rubber state at a temperature higher than the glass transition point so as to have a flexible structure, and thus, stress can be relieved. The present inventors have found that when tan δ within a temperature range in a thermal crack test or in an operating environment is large, the amount of stress generation is small, and furthermore, when Tg is in that range, stress is relaxed even when generated, resulting in suppression of breaking of the members. The sealant according to the present invention can satisfy the expression 1.3 GPa·s≦X≦5.0 GPa·s, where X is the elastic modulus in tension of the sealant at 25° C. When X is less than 1.3 GPa·s, elasticity is low and breaking of the member can be suppressed, but strength is also decreased. On the other hand, when X is more than 5.0 GPa·s, the amount of stress generation increases, and the degree of breaking of the member is also increased. Furthermore, in the sealant having a storage elastic modulus (E′) of 1.3 to 5.0 GPa·s, the expression 0.1≦Y≦5.0 can be satisfied, where Y is the maximum value of tan δ of the sealant at −30° C. to 60° C. When Y is less than 0.1, stress absorption is insufficient, which may result in breaking of the member. A material in which Y exceeds 5.0 is not a general material, but is a special material.

Since the sealant according to the present invention contains an epoxy resin having a bisphenol structure and a latent curing agent, in combination with the coefficient of linear expansion specified above, the sealant can be usefully used as a sealant for an inkjet head.

The epoxy resin having a bisphenol structure includes two or more oxirane groups in its molecule. Examples thereof include “EP-4000S” and “EP-4010S” manufactured by ADEKA. The epoxy resin can be a bisphenol A epoxy resin. Another type of epoxy resin may be used together therewith.

The latent curing agent is defined as a curing agent which can be stored for a long period of time while being mixed with an epoxy resin in advance, and which starts a curing reaction when a stimulus, such as heat, light, pressure, moisture, or the like is applied. Examples of the latent curing agent include tertiary amines, imidazoles, or salts thereof, which are dissolved or decomposed and activated to subject epoxy groups to self-polymerization by the anionic mechanism. For example, a solid dispersion-type amine-based latent curing agent may be used. The solid dispersion-type amine-based latent curing agent is an amine-based curing agent which is a solid insoluble in epoxy resins at room temperature (25° C.) and in a dispersed state, but which is dissolved by heating and exhibits a function as a curing agent. By using the latent curing agent, the working life can be prolonged. However, in some members, the heating temperature cannot be increased. Therefore, it is desirable to use a latent curing agent with a melting temperature of 100° C. or lower. In the present invention, an amine-epoxy adduct compound can be used. An amine-based curing agent is known to have excellent adhesiveness. The structure of the epoxy resin having a bisphenol structure used in the present invention is similar to the structure of modified polyphenylene ether serving as an adherend. Consequently, in the present invention, the epoxy resin having a bisphenol structure and the latent curing agent act synergistically, and it is possible to provide a sealant that can solve the problems described in items (1) to (4).

The sealant according to the present invention can contain 15 to 35 parts by mass, such as 15 to 30 parts by mass, of the latent curing agent relative to 100 parts by mass of the epoxy resin having a bisphenol structure.

The sealant according to the present invention can contain an inorganic filler. The coefficient of linear expansion can be satisfactorily adjusted by the inorganic filler. Examples of the inorganic filler include “FB-940” manufactured by Denki Kagaku Kogyo. The content of the inorganic filler can be 20 to 60 parts by mass relative to 100 parts by mass of the epoxy resin having a bisphenol structure.

In the present invention, in order to adjust a uniform, liquid sealant, the components described above can be mixed with a stirring-type disperser, dispersed with a bead mill, or dispersed and mixed with a triple roll mill. Examples of other additives that can be mixed include hybrid silicone powder, silicone rubber, modified nitrile rubber, olefin copolymers, modified polybutadiene rubber, silica fine particles (Aerosil) serving as a thixotropic agent, alumina, mica, oxide-containing polystyrene, and the like.

### (Inkjet Head)

An example in which a sealant for an inkjet head according to the present invention is used in an inkjet head will be described with reference to FIGS. 1A and 1B. FIG. 1A is an exploded perspective view showing a structure of an inkjet head, and FIG. 1B is a perspective view showing a state in which the members shown in FIG. 1A have been assembled.

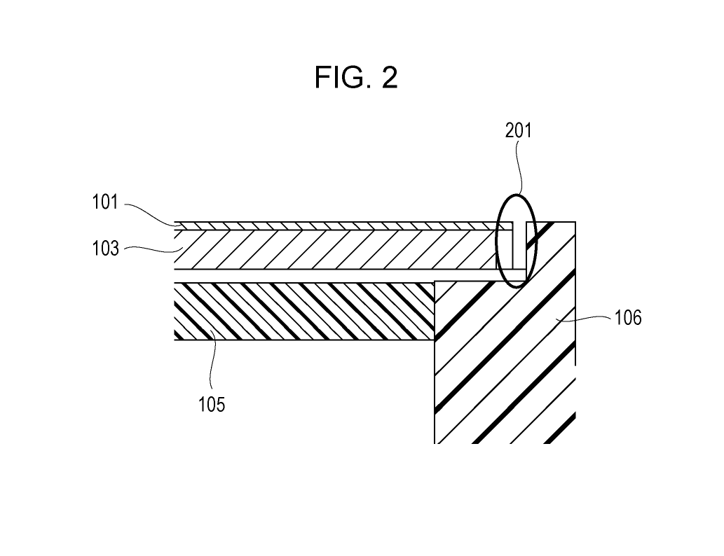

The inkjet head shown in FIG. 1A has a configuration in which a recording element unit 104, a chip plate 105, and a supporting member 106 are joined together. The recording element unit 104 includes an electric wiring sheet 101 fabricated by a TAB method, recording element substrates 102 having elements that generate energy for ejecting ink, and a deformation-preventing member 103 that prevents deformation of the electric wiring sheet 101. The supporting member 106 has an ink supply port 107 and a wiring substrate 108. The recording element unit 104 is supported by the chip plate 105 and the supporting member 106. As shown in FIG. 2, the chip plate 105 on which the recording element unit 104 is fixed is incorporated into the supporting member 106. In this case, the space between the deformation-preventing member 103 of the recording element unit 104 and the supporting member 106 is a filling portion 201 to be sealed with the sealant according to the present invention. Note that the location to be sealed with the sealant according to the present invention is not limited to the position shown in FIG. 2.

### Examples

The present invention will be described below on the basis of Examples. In the following description, “part” and “%” means “part by mass” and “% by mass”, respectively.

### <Members for Evaluation>

In the evaluation described below, when the members for a head having the structure shown in FIGS. 1A, 1B, and 2 were used, a deformation-preventing member 103 composed of alumina and a supporting member 106 composed of Noryl RN1300 (manufactured by GE Plastics), i.e., modified PPE, were used.

### <Sealant>

Using the starting materials shown in Tables 1 to 3, preparation was performed according to the composition (values in parts by mass) shown in Table 4 with a vacuum mixing-degassing mixer (V-mini300, manufactured by EME). Thereby, sealants used in Examples 1 to 14 and Comparative Example 1 were obtained. As a sealant in each of Comparative Examples 2 and 3, a commercially available ECCOBOND E-3210 (one-part thermosetting urethane-containing epoxy resin, amine-curing type) (manufactured by Henkel) was used.

TABLE 1

| | | |
|---|---|---|
| Base resin | Bisphenol A epoxy resin | EP-4000S (trade name), |
| | | manufactured by ADEKA |
| | | EP-4010S (trade name), |
| | | manufactured by ADEKA |
| | Bisphenol F epoxy resin | EP-49-23 (trade name), |
| | | manufactured by ADEKA |

TABLE 2

| | | |
|---|---|---|
| Latent curing agent | Imidazole-based latent | PN-23 (trade name), |
| | curing agent | manufactured by Ajinomoto |
| | | Fine-Techno |
| | Complex latent curing | AH-203 (trade name), |
| | agent | manufactured by Ajinomoto |
| | | Fine-Techno |

TABLE 3

| | | |
|---|---|---|
| Additive | Hybrid silicone | KMP-602 (trade name), manufactured |
| | powder | by Shin-Etsu Chemical |
| | Thixotropic agent | Aerosil 200 (trade name), |
| | | manufactured by Nippon Aerosil |
| | Inorganic filler | FB-940 (trade name), manufactured by |
| | | Denki Kagaku Kogyo |

TABLE 4

| | | | | | | | | | | | | | | | | Comparative |
|---|---|---|---|---|---|---|---|---|---|---|---|---|---|---|---|---|
| | | Example | | | | | | | | | | | | | | Example |
| | | 1 | 2 | 3 | 4 | 5 | 6 | 7 | 8 | 9 | 10 | 11 | 12 | 13 | 14 | 1 |
| Base | EP-4000S | 100 | 100 | 100 | 100 | 100 | 0 | 0 | 0 | 0 | 0 | 0 | 60 | 40 | 0 | 0 |
| resin | EP-4010S | 0 | 0 | 0 | 0 | 0 | 100 | 100 | 100 | 100 | 100 | 100 | 0 | 0 | 0 | 100 |
| | EP-49-23 | 0 | 0 | 0 | 0 | 0 | 0 | 0 | 0 | 0 | 0 | 0 | 40 | 60 | 100 | 0 |
| Curing | PN-23 | 0 | 0 | 0 | 0 | 0 | 0 | 0 | 0 | 0 | 0 | 15 | 0 | 0 | 0 | 15 |
| agent | AH-203 | 15 | 20 | 25 | 35 | 40 | 20 | 25 | 30 | 35 | 40 | 0 | 25 | 20 | 20 | 0 |
| Additive | KMP-602 | 0 | 0 | 0 | 0 | 0 | 0 | 0 | 0 | 0 | 0 | 0 | 0 | 0 | 60 | 0 |
| | Aerosil 200 | 3.8 | 3.8 | 3.8 | 3.8 | 3.8 | 3.5 | 3.5 | 3.5 | 3.5 | 3.5 | 3.5 | 3.5 | 3.6 | 3.6 | 3.5 |
| | FB-940 | 38 | 38 | 38 | 38 | 38 | 25 | 25 | 25 | 25 | 25 | 23.2 | 38 | 60 | 0 | 0 |

### <Evaluation>

Using the sealants described above, evaluation was performed as follows:

### (Physical Properties)

Cured products with a size of 30 mm in length×3 mm in width×1 mm in thickness were formed, and the physical properties of the sealants were measured as described below.

The elastic modulus (E′) and tan δ were measured using a dynamic viscoelasticity measurement apparatus DMS6100 (manufactured by Seiko Instruments, Inc.), in a tensile mode, with a sample length of 15 mm, at a measurement frequency of 1 Hz, at a rate of temperature increase of 2° C./min in the measurement temperature range of 20° C. to 120° C.

The coefficient of linear expansion (CTE) was measured using a thermal mechanical analyzer TMA/SS6100 (manufactured by Seiko Instruments, Inc.), in a tensile mode, with a sample length of 15 mm, at a tensile load of 50 mN, at a rate of temperature increase of 2° C./min below the glass transition temperature in the measurement temperature range of −30° C. to 120° C.

### (Evaluation Items)

### (1) Viscosity Reduction During Thermal Curing

The minimum viscosity of the sealant during thermal curing was measured with a rheometer. Using a liquid composition, the minimum viscosity was measured by a rheometer AR-G2 (manufactured by TA Instruments Ltd.), in an oscillation mode, with a sensing element with a diameter of 25 mm, aluminum parallel plates with a gap of 1 mm, at a measurement frequency of 1 Hz, at a rate of temperature increase of 5° C./min in the measurement temperature range of 25° C. to 100° C. The sealant with a minimum viscosity of 10 Pa·s or less was evaluated to be good (◯), and the sealant with a minimum viscosity of more than 10 Pa·s was evaluated to be poor (x).

### (2) Coating Performance

Using components for a head having the structure shown in FIGS. 1A, 1B, and 2, each of the sealants was continuously applied into the space between the recording element unit (deformation-preventing member) and the supporting member. The shape of the applied sealant was visually observed. The sealant with good shape retention was evaluated as ◯, and the sealant without good shape retention was evaluated as x.

### (3) Curing Performance

A cured product obtained by thermally curing 2.5 g of the sealant at 100° C. for 2 hours was immersed in 50 ml of clear ink at 121° C. under 2 atm for 10 hours, and then appearance of the cured product and the clear ink was visually observed. The clear ink was prepared using 9% of glycerol, 9% of triethylene glycol, 5% of methanol, 1% of acetylenol A100, and the balance being water. The case where no marked swelling or dissolution was observed in the cured product was evaluated to be good (◯), and the case where marked welling or dissolution was observed was evaluated to be poor (x).

### (4) Storage Stability

The sealant was stored at room temperature (25° C.), and an increase in viscosity relative to the viscosity before storage was observed. The viscosity was measured using an E-type viscometer at 25° C. The case where the ratio of increase in viscosity after 20 days was 1.3 times or less was evaluated to be very good (⊙), the case where the ratio of increase in viscosity after 7 days was 1.3 times or less, but the ratio of increase in viscosity after 20 days was more than 1.3 times was evaluated to be good (◯), and the case where the ratio of increase in viscosity after 7 days was more than 1.3 times was evaluated to be average (Δ).

### (5) Sealing Reliability

Using components for a head having the structure shown in FIGS. 1A, 1B, and 2, the space between the recording element unit (deformation-preventing member) and the supporting member was sealed with each of the sealants, and thermal curing was performed at 100° C. for 2 hours. In the case where a surface treatment (corona treatment) was performed on the supporting member 106, a corona discharge treatment was performed using a corona discharge treatment apparatus (manufactured by Kasuga Denki, Inc.). The treatment was performed under the conditions of a distance between works of 1 mm, a discharge output of 0.30 kW, and a treatment speed of 10 mm/sec in two cycles.

(5-1) Uniformity after Curing

The state of the sealant after thermal curing was visually observed. The case where a uniform solid was observed was evaluated to be good (◯), and the case where bubbles existed was evaluated to be poor (x).

(5-2) Flowing Out after Curing

The state of the sealant after thermal curing was visually observed. The case where the sealant was cured while remaining in the space (filling portion) was evaluated to be good (◯), and the case where the sealant was cured while being attached to portions other than the space was evaluated to be poor (x).

### (5-3) Appearance of Deformation-Preventing Member

Regarding 50 sets of components after thermal curing, a thermal crack test (10 cycles in total; one cycle consisting of −30° C. for 2 hours, 25° C. for 2 hours, 60° C. for 2 hours, and 25° C. for 2 hours) was carried out. The appearance of the deformation-preventing member after the test was visually observed. The case where no change was observed in all sets before and after the test was evaluated to be good (◯), the case where cracking in the deformation-preventing member after the test was observed in half or less of all sets was evaluated to be average (Δ), and the case where cracking occurred after the test in more than half of all sets was evaluated to be poor (x).

### (5-4) Destructive Test

The sealant after thermal curing was destroyed, and the state of the sealant and the members was visually observed. The case where cohesive failure occurred in the sealant or the members were destroyed was evaluated to be good (◯), and the case where interfacial peeling occurred in the sealant and the sealant was cured on any of the members was evaluated to be poor (x).

The evaluation results are shown in Table 5.

TABLE 5

| | | Example | | | | | | | | |
|---|---|---|---|---|---|---|---|---|---|---|
| | | 1 | 2 | 3 | 4 | 5 | 6 | 7 | 8 | 9 |
| Physical | E′ [GPa · s, 25° C.] | 2.5 | 2.5 | 2.6 | 3.1 | 3.2 | 1.3 | 3.7 | 3.2 | 3.2 |
| properties | Tan δ max(−30~60° C.) | 1.33 | 1.34 | 1.32 | 1.30 | 1.28 | 1.63 | 1.57 | 1.39 | 1.35 |
| | CTE [ppm/° C.] | 63 | 58 | 60 | 50 | 55 | 64 | 59 | 59 | 61 |
| Viscosity reduction | | ◯ | ◯ | ◯ | ◯ | ◯ | ◯ | ◯ | ◯ | ◯ |
| Coating performance | | ◯ | ◯ | ◯ | ◯ | ◯ | ◯ | ◯ | ◯ | ◯ |
| Curing performance | | ◯ | ◯ | ◯ | ◯ | ◯ | Δ | ◯ | ◯ | ◯ |
| Storage stability | | ⊙ | ⊙ | ⊙ | ⊙ | Δ | ◯ | ◯ | ◯ | ◯ |
| Sealing | Corona treatment | Not | Not | Not | Not | Not | Not | Not | Not | Not |
| reliability | | per- | per- | per- | per- | per- | per- | per- | per- | per- |
| | | formed | formed | formed | formed | formed | formed | formed | formed | formed |
| | Uniformity after curing | ◯ | ◯ | ◯ | ◯ | ◯ | ◯ | ◯ | ◯ | ◯ |
| | Flowing out after curing | ◯ | ◯ | ◯ | ◯ | ◯ | ◯ | ◯ | ◯ | ◯ |
| | Appearance of member | ◯ | ◯ | ◯ | ◯ | ◯ | ◯ | ◯ | ◯ | ◯ |
| | Destructive test | ◯ | ◯ | ◯ | ◯ | ◯ | ◯ | ◯ | ◯ | ◯ |

| | | | | | | | Comparative | | |
|---|---|---|---|---|---|---|---|---|---|
| | | Example | | | | | Example | | |
| | | 10 | 11 | 12 | 13 | 14 | 1 | 2 | 3 |
| Physical | E′ [GPa · s, 25° C.] | 3.1 | 3.1 | 4.3 | 4.8 | 1.4 | 2.9 | 1.2 | |
| properties | Tan δ max(−30~60° C.) | 1.32 | 0.79 | 1.01 | 0.94 | 0.04 | 0.77 | 0.36 | |
| | CTE [ppm/° C.] | 63 | 67 | 60 | 52 | 68 | 81 | 115 | |
| Viscosity reduction | | ◯ | ◯ | ◯ | ◯ | ◯ | ◯ | X | X |
| Coating performance | | ◯ | ◯ | ◯ | ◯ | ◯ | ◯ | ◯ | ◯ |
| Curing performance | | ◯ | ◯ | ◯ | ◯ | ◯ | ◯ | ◯ | ◯ |
| Storage stability | | Δ | ⊙ | ◯ | ⊙ | ⊙ | ⊙ | ◯ | ◯ |
| Sealing | Corona treatment | Not | Not | Not | Not | Not | Not | Not | Per- |
| reliability | | per- | per- | per- | per- | per- | per- | per- | formed |
| | | formed | formed | formed | formed | formed | formed | formed | |
| | Uniformity after curing | ◯ | ◯ | ◯ | ◯ | ◯ | ◯ | X | X |
| | Flowing out after curing | ◯ | ◯ | ◯ | ◯ | ◯ | ◯ | ◯ | ◯ |
| | Appearance of member | ◯ | ◯ | ◯ | Δ | Δ | X | ◯ | ◯ |
| | Destructive test | ◯ | ◯ | ◯ | ◯ | ◯ | ◯ | X | ◯ |

As shown in Table 5, the sealants of Examples 1 to 14 were evaluated to be Δ or higher in all of the items, and thus are satisfactory sealants for an inkjet head.

In contrast, in the sealants of Comparative Examples 1 to 3 having a high coefficient of linear expansion, at least one of viscosity reduction, uniformity after curing, resistance to thermal crack, and resistance to destruction was not satisfactory.

As is evident from the results described above, according to the present invention, it is possible to provide a sealant for an inkjet head (1) in which both shape retention and the uniform filling property can be achieved, (2) in which breaking of members due to sealing is suppressed, (3) which can satisfactorily join members together, and (4) which has a long working life.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-237518 filed Oct. 28, 2011, which is hereby incorporated by reference herein in its entirety.

What is claimed is:

1. A sealant for an inkjet head comprising:
an epoxy resin having a bisphenol structure; and
a latent curing agent,
wherein the sealant has a coefficient of linear expansion of 80 ppm/° C. or less.

2. The sealant for an inkjet head according to claim 1, wherein the expression 1.3 GPa·s≦X≦5.0 GPa·s is satisfied, where X is the elastic modulus in tension of the sealant at 25° C.

3. The sealant for an inkjet head according to claim 1, wherein the expression 0.1≦Y≦5.0 is satisfied, where Y is the maximum value of tan δ of the sealant at −30° C. to 60° C.

4. The sealant for an inkjet head according to claim 1, wherein the epoxy resin having a bisphenol structure is a bisphenol A epoxy resin.

5. An inkjet head comprising:
a recording element unit having a recording element configured to eject ink;
a supporting member that supports the recording element unit; and
a sealant that seals a space between the recording element unit and the supporting member,
wherein the sealant is the sealant for an inkjet head according to claim 1.

6. The inkjet head according to claim 5, wherein the recording element unit includes a member composed of alumina, the supporting member is composed of modified polyphenylene ether, and the sealant is a sealant that seals a space between the member composed of alumina and the supporting member.
